(19) United States
(12) Patent Application Publication
(10) Pub. No.: US 2008/0177938 A1
(43) Pub. Date: Jul. 24, 2008

(54) Hybrid hard disk drive, computer system including the same, and flash memory DMA circuit for hybrid HDD

(75) Inventor: Bum-seok Yu, Suwon-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Gyeonggi-do (KR)

(21) Appl. No.: 12/008,930

(22) Filed: Jan. 15, 2008

(30) Foreign Application Priority Data
Jan. 16, 2007 (KR) 10-2007-0004970

(51) Int. Cl. G06F 12/00

(52) U.S. Cl. 711/103; 711/E12.001

(57) ABSTRACT

Provided are a hybrid hard disk drive (HDD), a computer system including the hybrid HDD, and a flash memory DMA circuit for the hybrid HDD. The hybrid HDD includes a flash memory. The flash memory includes: a main memory region; and a spare memory region storing additional information necessary for transmitting user data stored in the main memory region. The flash memory DMA circuit of the hybrid HDD is used for interfacing the hybrid HDD with the flash memory. Therefore, rapid booting and low power consumption can be realized, while reducing overhead resulted from interfacing the hybrid HDD with the flash memory.

### CROSS-REFERENCE TO RELATED PATENT APPLICATION

This application claims the benefit of Korean Patent Application No. 10-2007-0004970, filed on Jan. 16, 2007, in the Korean Intellectual Property Office, the contents of which are incorporated herein in their entirety by reference.

### BACKGROUND OF THE INVENTION

1. Field of the Invention

The present invention relates to a memory device, and more particularly, to a hybrid hard disk drive (HDD), a computer system including the hybrid HDD, and a flash memory direct memory access (DMA) circuit for the hybrid HDD that are designed to achieve rapid booting, low power consumption, and overhead reduction by storing additional information into a spare memory region of the flash memory and providing a hardware interface for the flash memory.

2. Description of the Related Art

Data are read/written from/to a conventional hard HDD while disk platters are being rotated at a predetermined speed. Therefore, it takes time to rotate the disk platters to the predetermined speed for stabilizing the HDD after the HDD is powered on. In addition, much power is required to rotate the platters of the HDD.

Particularly, power consumption and booting time have become very important parameters with the increased use of mobile devices storing and transmitting multimedia data.

Thus, hybrid HDDs including flash memories have been intensively studied since a flash memory does not require a mechanical component, and thus the flash memory consumes less power and enables rapid booting of a system.

A hybrid HDD includes a flash memory and an interface for data transmission between the flash memory and other devices. In addition, the hybrid HDD may further include a mapping table for mapping a logical block address indicating the address of user data stored in the flash memory.

However, during an interfacing process (e.g., when the mapping table is processed using a software program), the hybrid HDD suffers from a large overhead of storing and transmitting user data. Therefore, when a hybrid HDD including a flash memory is used in a system, the performance of the system decreases due to overhead resulted from an interfacing process for the flash memory.

Thus, there is a need for an optimized flash memory structure and a DMA circuit for a hybrid HDD including a flash memory and a computer system using the hybrid HDD.

### SUMMARY OF THE INVENTION

The present invention provides a hybrid hard disk drive (HDD), a computer system including the hybrid HDD, and a flash memory direct memory access (DMA) circuit for the hybrid HDD in order to achieve rapid booting and low power consumption using a flash memory while reducing overhead resulted from interfacing the flash memory with the hybrid HDD.

According to an aspect of the present invention, there is provided a hybrid HDD (hard disk drive) comprising a flash memory. The flash memory includes a main memory region and a spare memory region storing additional information necessary for transmitting user data stored in the main memory region.

In one embodiment, the flash memory is used as a cache memory.

The additional information can comprise at least one of an LBA (logical block address) indicating a location of the user data in the flash memory and the number of valid sectors.

The user data can be transmitted in sectors or pages. The spare memory region can store LBAs corresponding to sectors of the main memory region when the user data are transmitted in sectors. The spare memory region can comprise a 16-byte space allocated for storing additional information for a 512-byte sector of the main memory region.

The spare memory region can store LBAs corresponding to pages of the main memory region when the user data are transmitted in pages. The spare memory region can comprise a 64-byte space allocated for storing additional information for a. 2-Kbyte page of the main memory region. Each of the pages of the main memory region can comprise four 512-byte sectors.

The number of valid sectors can indicate the number of valid sectors included in a sector or a page of the main memory region. The flash memory can be a NAND flash memory.

According to another aspect of the present invention, there is provided a computer system comprising a host computer and a hybrid HDD. The hybrid HDD includes a flash memory and a disk. The flash memory includes: a main memory region storing user data; and a spare memory region storing additional information necessary for transmitting the user data.

The computer system can further comprise a flash memory direct memory access (DMA) circuit for interfacing the hybrid HDD with the flash memory. The flash memory DMA circuit can be connected to interface circuits of the host computer, the disk, and the flash memory.

The computer system can further comprise a buffer memory. The flash memory DMA circuit can be connected to an interface circuit of the buffer memory. The buffer memory can be an SRAM (static random access memory) or DRAM (dynamic random access memory). The flash memory can be a NAND flash memory.

According to another aspect of the present invention, there is provided a flash memory DMA circuit for a hybrid HDD comprising a flash memory having a main memory region storing user data and a spare memory region storing additional information necessary for transmitting the user data, the flash memory DMA circuit including an interface circuit for interfacing the HDD with the flash memory.

The flash memory DMA circuit can further comprise a user data processor performing an interfacing operation for the user data, and a spare data processor performing an interfacing operation for the additional information.

The user data processor can comprise: a user data FIFO performing a synchronization operation for transmitting the user data; and an FF pattern generator recording an FF pattern in a remaining region of a page of the flash memory when the user data is smaller than the page of the flash memory.

The spare data processor can comprise: a mapping table processor performing a mapping operation for an LBA indication a location of the user data; and an error detection and correction unit detecting and correcting an error of the user data.

The mapping table processor can comprise a register storing at least one of a start LBA of the first sector of the user data to be transmitted, the number of transmitted sectors, the number of valid sectors. The error detection and correction unit can use a CRC (cycle redundancy check) error detection code.

The flash memory DMA circuit can be connected to interface circuits of a host computer, a disk, and the flash memory. The flash memory DMA circuit can further comprise a register storing an address and a size of data for data communication with at least one of the host computer, the disk, and the flash memory.

The flash memory DMA circuit can be connected to an interface circuit of a buffer memory. The flash memory DMA circuit can further comprise a register storing an address and a size of data for data communication with the buffer memory.

### BRIEF DESCRIPTION OF THE DRAWINGS

The foregoing and other features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic block diagram illustrating a computer system including a hybrid hard disk drive (HDD) according to an embodiment of the present invention.

FIG. 2 is a block diagram illustrating a flash memory structure for transmitting user data in sectors in the computer system depicted in FIG. 1, according to an embodiment of the present invention.

FIG. 3 is a block diagram illustrating a flash memory structure for transmitting user data in sectors to the computer system depicted in FIG. 1, according to an embodiment of the present invention.

FIG. 4 is a block diagram illustrating a flash memory direct memory access (DMA) circuit connected to other components in the computer system depicted in FIG. 1, according to an embodiment of the present invention.

FIG. 5 is a detailed block diagram illustrating the flash memory DMA circuit depicted in FIG. 4, according to an embodiment of the present invention.

### DETAILED DESCRIPTION OF PREFERRED EMBODIMENTS OF THE INVENTION

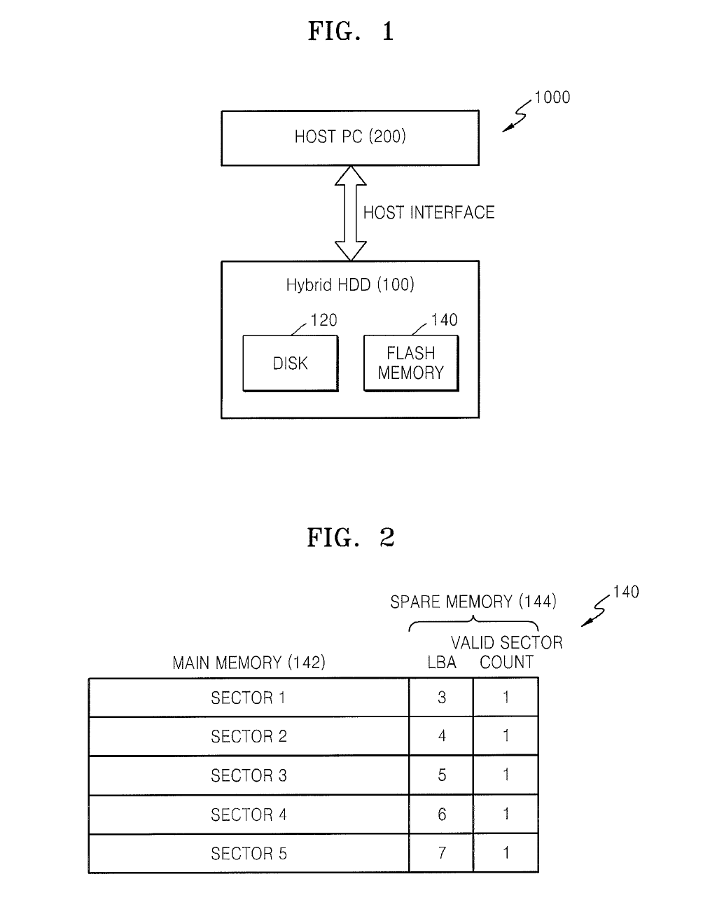

FIG. 1 is a schematic block diagram illustrating a computer system 1000 including a hybrid hard disk drive (HDD) 100 according to an embodiment of the present invention.

Referring to FIG. 1, the computer system 1000 includes a host computer 200 and the hybrid HDD 100. The hybrid HDD includes a flash memory 140 and a disk 120.

The flash memory 140 may be a NAND flash memory (particularly, OneNAND flash memory). The flash memory 140 can be used as a cache memory. In this case, the hybrid HDD 100 stores mapping table information for a logical block address of the flash memory 140.

An operating system (OS) of the host computer 200 can accesses both the disk 120 and the flash memory 140. The OS of the host computer 200 stores data such as boot data into the flash memory 140 before the computer system 1000 is powered off so that the hybrid HDD 100 can achieve rapid booting.

The structure of the flash memory 140 of the hybrid HDD 100 of FIG. 1 and a flash memory direct memory access (DMA) circuit interfaced with the flash memory 140 will now be described according to embodiments of the present invention.

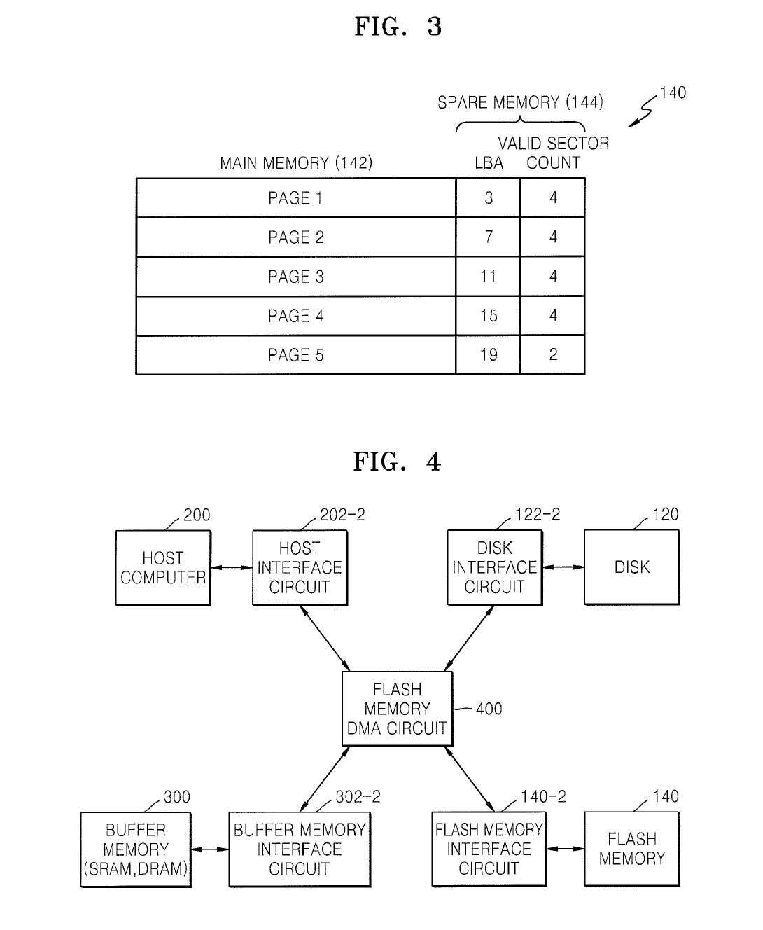

FIG. 2 is a block diagram illustrating a flash memory structure for transmitting user data in sectors in the computer system depicted in FIG. 1, according to an embodiment of the present invention, and FIG. 3 is a block diagram illustrating a flash memory structure for transmitting user data in sectors in the computer system depicted in FIG. 1, according to an embodiment of the present invention.

Referring to FIGS. 2 and 3, according to an embodiment of the present invention, the flash memory 140 includes a main memory region 142 storing user data and a spare memory region 144 storing additional information required for transmitting the user data. The additional information may include a logical block address (LBA) of the flash memory 140 and valid sector count information.

The user data are transmitted in sectors or pages. The transmission of user data means data transmission between the flash memory 140 and other components (e.g., the host computer 200 and the disk 120) in the computer system 1000 (refer to FIG. 1). In the embodiments of FIGS. 2 and 3, the flash memory 140 transmits or stores user data in 512-byte sectors or 2-Kbyte pages.

In the embodiment of FIG. 2, the flash memory 140 transmits user data in sectors. Referring to FIG. 2, in the spare memory region 144,16 bytes can be used to store additional information for each 512-byte sector of the main memory region 142.

FIG. 2 illustrates an exemplary data status of the flash memory 140, in which an LBA (start LBA) of the first sector 1 is three and the number of sectors to be transmitted is five. The start LBA and the number of sectors can be stored into a register of a spare data processor of a flash memory DMA circuit (described later).

In the spare memory region 144, LBAs corresponding to sectors 1 through 5 of the main memory region 142 are stored. The LBAs of the sectors 2 through 5 have values obtained by adding the number of transmitted sectors to the value of the start LBA.

For example, in the spare memory region 144 of FIG. 2, the LBA (“3”) of the first sector 1 is stored as a start LBA value. Then, a value obtained by adding the number of transmitted sectors to the LBA value of the first sector 1 is stored as the LBA value of the second sector 2 (4=3+1). In this way, values for the LBAs of the sectors 1 through 5 are stored.

In the spare memory region 144, each cell of a valid sector count column indicating the number of valid sectors of the main memory region 142 may have a value of “0” or “1”. In FIG. 2, since five valid sectors are stored in the main memory region 142, all cells of the valid sector count column have the same value of 1.

FIG. 3 illustrates a structure of the flash memory 140 for transmitting user data in units of pages according to an embodiment of the present invention. Referring to FIG. 3, in a spare memory region 144, 64 bytes can be used to store additional information for each 2-Kbyte page of a main memory region 142.

In FIG. 3, an LBA (start LBA) of the first sector of the first page 1 is three, and eighteen sectors are divided into five pages for transmission. In the current embodiment, each of pages 1 through 5 of the flash memory 140 includes four 512-byte sectors. However, the size of each page of the flash memory 140 can be larger than 2 Kbytes or include 4 sectors or more according to another embodiment of the present invention.

In the spare memory region 144, LBAs corresponding to pages 1 through 5 of the main memory region 142 are stored. An LBA of the first sector of each page is stored as the LBA of the page. The LBAs of the pages 2 through 5 have values obtained by adding the number of transmitted sectors to the value of the start LBA in the same manner as in FIG. 2. Therefore, when each page includes four sectors, a difference between LBAs of two consecutive pages is “4”.

For example, in the spare memory region 144 of FIG. 3, the LBA (“3”) of the first page 1 is stored as a start LBA value. Then, a value obtained by adding the number of transmitted sectors to the LBA value of the first page 1 is stored as the LBA value of the second page 2 (7=3+4). In this way, values for the LBAs of the pages 1 through 5 are stored.

In the spare memory region 144, each cell of a valid sector count column indicating the number of valid sectors of the main memory region 142 may have a value in the range of zero to four. In FIG. 3, since eighteen valid sectors are consecutively stored in the main memory region 142, the values of the cells of the valid sector count column for the pages 1 through 4 are four, and the value of the cell for the page 5 is two.

Unlike the embodiment of FIG. 3, LBAs of all sectors included in a page can be stored in the spare memory region 144 as an LBA for the page. For example, “3”, “4”, “5”, and “6” can be stored in the spare memory region 144 as an LBA of the first page 1.

The hybrid HDD 100 with the flash memory 140 described in FIGS. 2 and 3 or the computer system 1000 with the hybrid HDD 100 may further include a flash memory DMA circuit as hardware for interfacing the hybrid HDD 100 with the flash memory 140.

FIG. 4 is a block diagram illustrating a flash memory DMA circuit 400 connected to other components in the computer system 1000 depicted in FIG. 1, according to an embodiment of the present invention.

Referring to FIG. 4, the flash memory DMA circuit 400 is connected to a host interface circuit 200-2, a disk interface circuit 120-2, and a flash memory interface circuit 140-2. The flash memory DMA circuit 400 can include a common register (not shown) to store an address and size of data for data communication with the host computer 200, the disk 120, and the flash memory 140. Alternatively, the flash memory DMA circuit 400 can include registers (not shown) for respective devices.

The flash memory DMA circuit 400 can be connected to a buffer memory interface circuit 300-2. A buffer memory 300 may be a static random access memory (SRAM) or dynamic random access memory (DRAM). The flash memory DMA circuit 400 may further include a register (not shown) to store an address and size of data for data communication with the buffer memory 300. When the computer system 1000 include the buffer memory 300, the flash memory DMA circuit 400 can directly store data received from the host computer 200 into the flash memory 140 or can store the data into the flash memory after changing the order of packets of the data using the buffer memory 300.

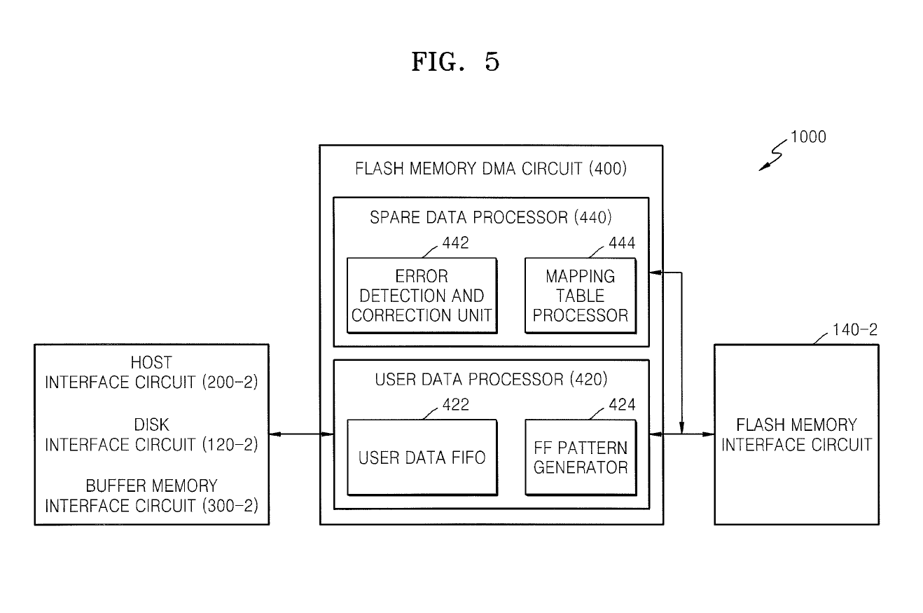

FIG. 5 is a detailed block diagram illustrating the flash memory DMA circuit 400 depicted in FIG. 4, according to an embodiment of the present invention.

Referring to FIG. 5, the flash memory DMA circuit 400 includes a user data processor 420 for user data interfacing and a spare data processor 440 for additional data interfacing.

The user data processor 420 includes a user data FIFO 422 and a FF pattern generator 424. The user data FIFO 422 is used for synchronization of user data transmission. That is, the user data FIFO 422 is used for compensating for data rate differences between interfaces of FIG. 5. When user data is smaller than a page of the flash memory 140, the FF pattern generator 424 records an FF pattern on a remaining region of the page since data are recorded in the flash memory 140 in pages.

The spare data processor 440 includes a mapping table processor 444 and an error detection and correction unit 442. The mapping table processor 444 performs a mapping operation for an LBA of user data. The mapping table processor 444 can include a register storing at least one of an LBA (start LBA) of the first sector of transmission data, the number of transmitted sectors, and the number of valid sectors.

The error detection and correction unit 442 detects and corrects errors in user data. In the current embodiment, the error detection and correction unit 442 uses a cycle redundancy check (CRC) error detection code. In a conventional OneNAND flash memory, errors are detected and corrected in a 1-bit correction and 2-bit detection manner using an error correction code (ECC). Therefore, for example, when a 3-bit or larger error occurs due to unexpected power-off situation, data can be damaged.

However, in the current embodiment of the present invention, the flash memory DMA circuit 400 supports 32-bit CRC circuit, so that a plurality of error bits can be detected. Furthermore, the flash memory DMA circuit 400 supporting 32-bit CRC circuit increases the writing performance of the flash memory 140 since an additional writing operation is not required in the case of an unexpected power-off situation.

In the hybrid HDD, the computer system with the hybrid HDD, and the flash memory DMA circuit for the hybrid HDD of the present invention, the flash memory includes a spare memory region storing additional information necessary for user data transmission, and the flash memory DMA circuit is used as hardware for interfacing the hybrid HDD with the flash memory. Therefore, the computer system has the advantages of a hybrid HDD, and overhead resulted from interfacing the flash memory with the hybrid HDD can be reduced.

Furthermore, the computer system of the present invention can achieve rapid booting and low power consumption, while reducing overhead resulted from interfacing the hybrid HDD with the flash memory.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A hybrid HDD (hard disk drive) comprising a flash memory, wherein the flash memory comprises:
a main memory region; and
a spare memory region storing additional information necessary for transmitting user data stored in the main memory region.

2. The hybrid HDD of claim 1, wherein the flash memory is used as a cache memory.

3. The hybrid HDD of claim 1, wherein the additional information comprises at least one of an LBA (logical block address) indicating a location of the user data in the flash memory and the number of valid sectors.

4. The hybrid HDD of claim 3, wherein the user data are transmitted in sectors or pages.

5. The hybrid HDD of claim 4, wherein the spare memory region stores LBAs corresponding to sectors of the main memory region when the user data are transmitted in sectors.

6. The hybrid HDD of claim 5, wherein the spare memory region comprises a 16-byte space allocated for storing additional information for a 512-byte sector of the main memory region.

7. The hybrid HDD of claim 4, wherein the number of valid sectors indicates the number of valid sectors included in a sector or a page of the main memory region.

8. A computer system comprising:
a host computer; and
a hybrid HDD including a flash memory and a disk,
wherein the flash memory includes:
a main memory region storing user data; and
a spare memory region storing additional information necessary for transmitting the user data.

9. The computer system of claim 8, further comprising a flash memory direct memory access (DMA) circuit for interfacing the hybrid HDD with the flash memory.

10. The computer system of claim 9, wherein the flash memory DMA circuit is connected to interface circuits of the host computer, the disk, and the flash memory.

11. A flash memory DMA circuit for a hybrid HDD including a flash memory having a main memory region storing user data and a spare memory region storing additional information necessary for transmitting the user data, the flash memory DMA circuit comprising interface circuit for interfacing the HDD with the flash memory.

12. The flash memory DMA circuit of claim 11, further comprising:
a user data processor performing an interfacing operation for the user data; and
a spare data processor performing an interfacing operation for the additional information.

13. The flash memory DMA circuit of claim 12, wherein the user data processor comprises:
a user data FIFO performing a synchronization operation for transmitting the user data; and
an FF pattern generator recording an FF pattern in a remaining region of a page of the flash memory when the user data is, smaller than the page of the flash memory.

14. The flash memory DMA circuit of claim 12, wherein the spare data processor comprises:
a mapping table processor performing a mapping operation for an LBA indication a location of the user data; and
an error detection and correction unit detecting and correcting an error of the user data.

15. The flash memory DMA circuit of claim 14, wherein the mapping table processor comprises a register storing at least one of a start LBA of the first sector of the user data to be transmitted, the number of transmitted sectors, the number of valid sectors.

16. The flash memory DMA circuit of claim 14, wherein the error detection and correction unit uses a CRC (cycle redundancy check) error detection code.

17. The flash memory DMA circuit of claim 11, wherein the flash memory DMA circuit is connected to interface circuits of a host computer, a disk, and the flash memory.

18. The flash memory DMA circuit of claim 17, further comprising a register storing an address and a size of data for data communication with at least one of the host computer, the disk, and the flash memory.

19. The flash memory DMA circuit of claim 17, wherein the flash memory DMA circuit is connected to an interface circuit of a buffer memory.

20. The flash memory DMA circuit of claim 19, further comprising a register storing an address and a size of data for data communication with the buffer memory.
